(19) United States
(12) Patent Application Publication
(10) Pub. No.: US 2007/0236645 A1
(43) Pub. Date: Oct. 11, 2007

(54) Liquid crystal display panel and method of manufacturing the same

(75) Inventor: Yoshiaki Hashimoto, Kanagawa (JP)

Correspondence Address: YOUNG & THOMPSON, 745 SOUTH 23RD STREET, 2ND FLOOR, ARLINGTON, VA, 22202, US

(73) Assignee: NEC LCD TECHNOLOGIES, LTD., Kanagawa (JP)

(21) Appl. No.: 11/730,837

(22) Filed: Apr. 4, 2007

(30) Foreign Application Priority Data
Apr. 5, 2006 (JP) 2006-104520

(51) Int. Cl. G02F 1/1339

(52) U.S. Cl. 349/155

(57) ABSTRACT

In a liquid crystal display panel using spherical spacers, plural recessed parts are formed on at least one of inner surfaces of a pair of substrates. The recessed parts are located on light-shielding areas of the panel. In particular, plural kinds of spherical spacers having different diameters are disposed on the recessed parts, or plural kinds of recessed parts having different depths are formed on the inner surface of the substrates.

### BACKGROUND OF THE INVENTION

1. Field of the Invention

The present invention relates to a liquid crystal display panel and a method of manufacturing the same, and more specifically to a liquid crystal display panel using spherical spacers and a method of manufacturing the same.

2. Description of the Related Art

Liquid crystal display (LCD) devices have been widely used as display devices for audio-visual (AV) devices or office automation (OA) devices since they have the advantages that they are lightweight and thin, and that they have low power consumption. Such an LCD device includes a liquid crystal display panel (LCD panel) in which liquid crystal material is sandwiched between an active matrix substrate and a counter substrate. The active matrix substrate is provided with switching elements such as thin film transistors (TFTs) formed thereon in matrix. The counter substrate is provided with color filters (CFs) and black matrixes (BMs) formed thereon. The alignment direction of liquid crystal molecules is controlled with an electric field generated between electrodes provided to one or both of the substrates, whereby light transmittance is changed, so that image displaying according to input display data is achieved.

To enhance the display quality of the above-described LCD panel, it is important to control the gap, that is a cell gap, between the active matrix substrate and the counter substrate. Normally, spacer members having predetermined shape and size, e.g. spherical or columnar spacers, are disposed between the substrates. Particularly, LCD devices, in which columnar spacers are disposed at fixed points on light-shielding parts, for high-performance use with high response speed, high fineness and high contrast have been proposed in Japanese Laid-Open Patent No. 2004-21199, Japanese Laid-Open Patent No. Hei 6-88964, Japanese Laid-Open Patent No. Hei 6-347802 and Japanese Laid-Open Patent No. 2001-154204.

For example, in Japanese Laid-Open Patent No. 2004-21199, on an area corresponding to a light-shielding area, there is an alignment film, the contact angle of which relative to a dispersion liquid containing spacer particles is θa. On the other hand, on an area corresponding to a pixel area, there is an alignment film, the contact angle of which relative to a dispersion liquid containing spacer particles is θb. In the above-described document, there is disclosed a method in which, by using a substrate satisfying the condition that θa<θb, a dispersion liquid containing spacer particles is discharged to a part having a contact angle, θa, so that the accuracy of print position is enhanced.

Incidentally, the columnar spacers have the characteristics that the elasticity thereof is low in general as compared with that of the spherical spacers, and that the non-uniformity of the gap tends to occur due to a volumetric change of liquid crystal material or the like when the columnar spacers are subjected to a temperature change, and that non-uniformity in display tends to occur due to strains caused by stresses. In recent years, an ongoing advancement in narrowing the gap causes the problems that non-uniformity of the gap occurs due to a volumetric change of liquid crystal material or the like when the columnar spacers are subjected to a temperature change and/or that non-uniformity in display occurs due to strains generated by stresses.

In addition, even in an LCD device configured in such a manner that spherical spacers are disposed on light-shielding parts, the spacers are disposed outside the light-shielding areas due to the non-uniformity of the accuracy of the positions of the spacers. This brings about problems of light leakage, the non-uniformity of gap and a reduction in contrast. Moreover, although Japanese Laid-Open Patent No. 2004-21199 discloses that the accuracy of print positions is enhanced by changing a contact angle, a surface condition becomes unstable due to a pattern shape and, consequently, use of this structure alone does not allow spacers to be accurately disposed.

Furthermore, even when there is no problem in the initial display condition, there is a case where the spacers are caused to move to the outside of the light-shielding areas due to vibration and/or impact which occur while being transported. Such movement of the spacers also produces the problems of light leakage, the non-uniformity of the gap and a reduction in contrast, as described above.

### SUMMARY OF THE INVENTION

Accordingly, an exemplary feature of the invention is to provide an LCD panel capable of controlling non-uniformity of a gap due to a temperature change and non-uniformity in display due to strains caused by stresses, and to provide a method of manufacturing the same.

An LCD panel of the present invention includes: a pair of substrates sandwiching liquid crystal material, at least one of the substrates have light-shielding parts viewing from normal direction to the substrate, plural recessed parts provided on the light-shielding parts; and

plural spherical spacers disposed on the recessed parts and controlling a gap between the pair of substrates in such a manner that there exists at least two different ratios of the gap at the recessed part to a diameter of the spacer disposed on the recessed part.

It is preferred that the spherical spacers include plural kinds of spherical spacers, the diameters of which are different from one another to provide the different ratios.

It is preferred that the spherical spacers include first spherical spacers having a relatively large diameter and second spherical spacers having a relatively small diameter, and the number of the second spherical spacers is larger than that of the first spherical spacers.

It is preferred that the difference in diameter of the first spherical spacers and the second spherical spacers is in the range of approximately 2% to 20% of the diameter of the first spherical spacers.

It is preferred that the plural recessed parts include plural kinds of recessed parts, the depths of which are different from one another to provide the different ratios.

It is preferred that the plural kinds of recessed parts include first recessed parts having a relatively small depth and second recessed parts having a relatively large depth, and the number of the second recessed parts is larger than that of the first recessed parts.

It is preferred that the difference in depth between the first recessed parts and the second recessed parts is in the range of approximately 2% to 20% of the diameter of the spherical spacers.

It is preferred that a near area surrounding each of the recessed parts is formed of a member having a contact angle larger than that of at least an area of an inner surface of the recessed part.

It is preferred that at least an inner surface of each recessed part is formed of an inorganic film, and the near area surrounding each of the recessed part is formed of a photoreactive organic film.

It is preferred that on a near area surrounding each of the recessed parts, there is disposed a member having a contact angle larger than that of an area of the inner surface of the recessed part.

It is preferred that an inner surface of each recessed part is formed of an insulating film, and the near area surrounding each of the recessed parts is formed of a transparent conductive film.

It is preferred that the area where the light is shielded is an area on which a metallic wiring or a black matrix is formed.

In the present invention, a method of manufacturing an LCD panel, comprising:

a first step of forming plural recessed parts on an inner surface of at least one of a pair of substrates such that the recessed parts are located at a place where light is shielded in a direction normal to the substrate, and the surface being a liquid crystal sandwiching surface used to support the liquid crystal material;

a second step of disposing spherical spacers on the plural recessed parts; and

a third step of overlapping the pair of substrates for engaging the spherical spacers with the recessed parts between the substrates.

It is preferred that the spherical spacers include plural kinds of spherical spacers, the diameters of which are different from one another; and, in the third step, the spherical spacers each having a large diameter and the recessed parts are engaged, and the pair of substrates are overlapped.

It is preferred that the spherical spacers include first spherical spacers each having a relatively large diameter and second spherical spacers each having a relatively small diameter, and the second spherical spacers and the first spherical spacers are disposed so that the number of the second spherical spacers is larger than that of the first spherical spacers.

It is preferred that in the second step, inks in which plural kinds of spherical spacers having diameters different from one another, respectively, are dispersed are discharged through separate ink jet nozzles so that the plural kinds of spherical spacers having different diameters are disposed on plural recessed parts.

It is preferred that, in the fist step, plural recessed parts, the depths of which are different from one another, are formed.

It is preferred that, in the third step, the spherical spacers and the recessed parts each having a small depth are engaged, and the pair of substrates are overlapped.

It is preferred that the plural recessed parts include first recessed parts each having a relatively small depth and second recessed parts each having a relatively large depth, and the first and second recessed parts are formed so that the number of the second recessed parts is larger than that of the first recessed parts.

It is preferred that, a contact angle of a near area surrounding each of the recessed parts is made larger than a contact angle of at least a part of the inner surface of the recessed part by forming plural members each having a different contact angle on the near area surrounding the recessed part, or by disposing a member having a contact angle larger than the contact angle of at least the part of the inner surface of the recessed part on the near area surrounding the recessed part.

According to the LCD panel and the method of the present invention of manufacturing the same, the following advantages are produced.

A first advantage of the present invention is that it is possible to control the non-uniformity of the gap, which occurs when the spacers are subjected to a temperature change, and non-uniformity in display which occurs due to strains generated by stresses. This is because, on recessed parts provided to at least one of a pair of substrates facing each other, plural kinds of spherical spacers having different diameters are disposed or plural kinds of recessed parts having different depths are formed, whereby there are formed parts which constantly support the substrates therebetween and parts which normally do not support the substrates so much and, however, support the same when a load is locally applied, thus enabling enhancement of the performance of following of the spacers to a gap change due to a temperature change.

A second advantage of the present invention is that it is possible to increase a margin for a change in the gap. This is because the spherical spacers having elastic forces larger than those of the columnar spacers, are used as the spacer members and, furthermore, the spherical spacers are disposed on the recessed part whereby the diameters of the spherical spacers can be set to be larger than the cell gap.

Furthermore, a third advantage of the present invention is that it is possible to provide products, which are highly reliable to the vibration and impact and which has no light leakage and has high contrast. This is because the spherical spacers are disposed on the recessed parts formed in the light-shielding areas whereby the moving of the spherical spacers is structurally restrained, so that the spherical spacers do not move to a display part even when undergoing vibration and impact due to the transportation of the products, or the like.

### BRIEF DESCRIPTION OF THE DRAWINGS

These and other objects and advantages and further description of the invention will be more apparent to those skilled in the art by reference to the description, taken in connection with the accompanying drawings, in which:

FIG. 1 is a plan view showing a TFT substrate constituting an LCD panel according to a first exemplary embodiment of the present invention;

FIG. 2 is a cross sectional view of the LCD panel taken along the line I-I of FIG. 1;

FIG. 3A is a flowchart for the purpose of describing a method of manufacturing the LCD panel according to the first exemplary embodiment of the present invention;

FIG. 3B is a schematic view for the purpose of describing the ink jet head which discharges ink by an ink jet method;

FIG. 4 is a plan view showing another structure of the TFT substrate forming the LCD panel according to the first exemplary embodiment of the present invention;

FIG. 5 is a cross sectional view of an LCD panel according to a second exemplary embodiment of the present invention;

FIG. 6 is a cross sectional view showing another structure of the LCD panel according to a second exemplary embodiment of the present invention;

FIG. 7 is a cross sectional view of an LCD panel according to a third exemplary embodiment of the present invention;

FIG. 8 is a cross sectional view showing another structure of the LCD panel according to the third exemplary embodiment of the present invention;

FIG. 9 is a cross sectional view showing a structure of an LCD panel according to a fourth exemplary embodiment of the present invention; and

FIG. 10 is a cross sectional view showing a step of manufacturing the LCD panel according to the fourth exemplary embodiment of the present invention.

### DETAILED DESCRIPTION OF THE PREFERRED EMBODIMENTS

To enhance the display quality of the LCD panel, it is important to control the gap between the active matrix substrate and the counter substrate. To achieve the controlling, spacers are disposed between the substrates. However, there are the problems that the non-uniformity of the gap tends to occur due to a volumetric change of liquid crystal material or the like when the spacers are subjected to a temperature change and/or that non-uniformity in display tends to occur due to strains generated by stresses.

Therefore, although it is necessary to form liquid crystal cells with spacers compressed within the range of elastic deformation so that the spacers are capable of following during the increase in temperature, when excessively increasing the density of the spacers, there occur problems that a desired gap cannot be formed and/or that air bubbles and the like are generated. On the other hand, when a supporting force becomes too small since the density of the spacers is too small, there occurs a problem that, when the substrate is put in upright position, liquid crystal material move downward by self-weight to stay at a low level thus causing non-uniformity in display or that, when a load is locally applied, spacers undergo plastic deformation thus causing non-uniformity in display.

To control such non-uniformity of the gap, it is necessary to set the density of the spacers to be in an adequate range. In the present invention, recessed parts are formed on at least one of a pair of substrates facing each other. Further, on these recessed parts, multiple kinds of spherical spacers each having a different diameter are disposed, or multiple kinds of recessed parts each having a different depth are formed. Hence, there can be formed parts which constantly support the substrates and parts which normally do not support the substrates so much, but do support the same when a load is locally applied. Therefore, it is possible to provide a product which has a large margin for the non-uniformity of the gap generated by a temperature change and which is highly resistant to the locally applied load. A detailed description is given below with reference to the accompanying drawings.

### First Exemplary Embodiment

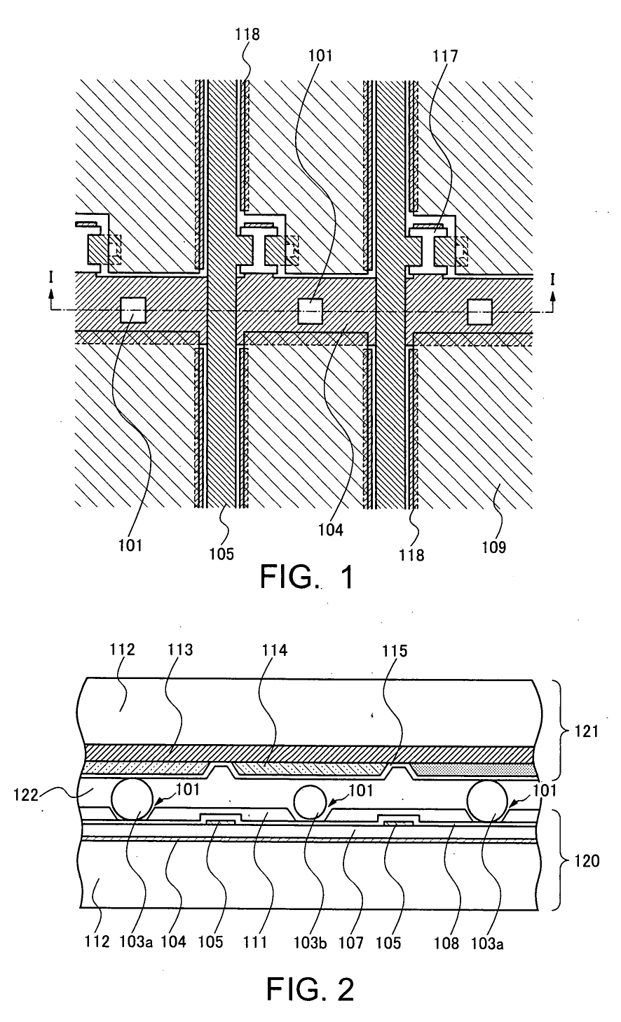

First, an LCD panel of a first exemplary embodiment of the present invention and a method of manufacturing the LCD panel are described with reference to FIGS. 1, 2, 3A and 3B.

An LCD device of the present embodiment includes an LCD panel, a backlight unit illuminating the LCD panel and the like. As shown in FIGS. 1 and 2, the LCD panel mainly includes an active matrix substrate, a counter substrate facing the active matrix substrate, approximately spherical-shaped spherical spacers which are disposed between the active matrix substrate and the counter substrate, and liquid crystal material 122 sandwiched in a cell gap delimited by the spherical spacers. On the active matrix substrate, switching elements such as TFTs are formed in matrix. In the present embodiment, an example of the active matrix substrate is described by using a TFT substrate 120. An example of the counter substrate is described by using a color filter (CF) substrate 121. Examples of the approximately spherical-shaped spherical spacers are described by using spherical spacers 103a and 103b. Incidentally, the cell gap normally designates the spacing between a surface of a pixel electrode of the active matrix substrate and a surface of a counter electrode of the counter substrate. In the present invention, since recessed parts are formed on at least one of the substrates, for the sake of description, the spacing between main surfaces (substantially flat surfaces except the recessed parts) of both of the substrates is defined as the cell gap.

As shown in FIG. 2, the CF substrate 121 mainly includes a transparent insulating substrate (i.e. a glass substrate 112) made of glass, plastic or the like; a black matrix 113 and color layers 114 formed by a photolithographic method; and a counter electrode 115 formed by a sputtering method.

As shown in FIGS. 1 and 2, the TFT substrate 120 includes a transparent insulating substrate (i.e. a glass substrate 112) made of glass, plastic or the like; gate wirings 104 (scan lines) formed by a photolithographic method and gate light-shielding parts 118 which shield light along the peripherals of pixels; gate insulating films 107; and TFTs 117 formed of amorphous silicon, polycrystalline silicon or the like. Furthermore, the TFT substrate 120 includes drain wirings 105 (signal lines) formed by a photolithographic method, each wiring being connected to one electrode of each of the TFTs 117; a passivation film 108; a flattened film 111 formed of a photosensitive organic film or the like; recessed parts 101 formed by removing part of the flattened film 111 in light-shielding areas; and pixel electrodes 109 formed by a photolithographic method, each electrode being connected to the other electrode of each of the TFTs 117. Moreover, multiple kinds of spherical spacers each having a different diameter are disposed on the recessed parts 101 by an ink jet method. The ratio of the gap at the recessed part 101 to the diameter of the spherical spacer 103a disposed on the recessed part 101 is thereby different from the ratio of the gap at the recessed part 101 to a diameter of the spherical spacer 103b disposed on the recessed part 101. In the present embodiment, the recessed parts 101 in the light-shielding areas are formed by selectively removing part of the flattened film 111 in the light-shielding areas such as the drain wirings 105 and the gate wirings 104. Furthermore, in the present embodiment, as the multiple kinds of spherical spacers each having different a diameter, spherical spacers 103a each having a relatively large diameter and spherical spacers 103b each having a relatively small diameter are used. A description of plural aforementioned recessed parts 101 disposed in the light-shielding areas of the TFT substrate 120 is given, assuming that they are formed to have the same depth.

There is no particular limitation on the film thicknesses and sizes of respective members constituting the above-described LCD panel. However, for example, it is assumed that the thickness of the flattened film 111 is 1.0 μm; the diameter of the spherical spacer 103a is 4.2 μm; and the diameter of the spherical spacer 103b is 3.8 μm. Here, the spacing between a main surface of the flattened film 111 and the counter electrodes 115 is defined as the cell gap. When setting this cell gap to 3.0 μm and when forming the cell in a state where the spherical spacers 103a are being compressed by 0.2 μm, the spherical spacers 103b are put in a state where the same are free to move by 0.2 μm.

Incidentally, as to the disposition densities of the spherical spacers 103a and the spherical spacers 103b, since the both substrates facing each other are mainly supported with the spherical spacers 103a and since the same are supported with the spherical spacers 103b when the gap is changed, the disposition density of the spherical spacers 103b which are disposed secondarily is desired to be approximately several times greater than the disposition density of the spherical spacers 103a with which the both substrates are mainly supported. It is possible to adjust this disposition density by the number of disposing points and/or by the number of spacers disposed at one place. Furthermore, when adjusting the disposition place, plural lines of ink-jet nozzles are prepared, and then, inks in which the spherical spacers having respective diameters are dispersed are discharged through the respective ink-jet nozzles, whereby it is possible to dispose desired spherical spacers on arbitrary recessed parts 101.

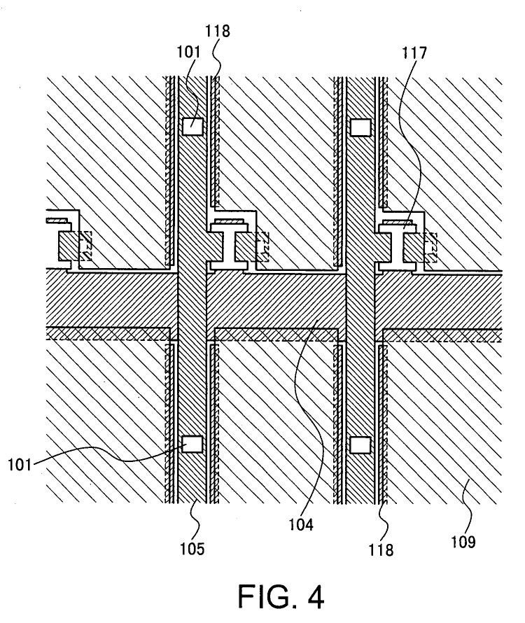

The shapes of the spherical spacers 103a and 103b are not necessarily precisely spherical and may be of slightly deformed ellipsoid-like shape. In addition, the materials of the spacers 103a and 103b are not limited to polymer beads or silica beads. Although it is only expected herein that the size of the spherical spacer 103a is larger than that of the spherical spacer 103b, it has been confirmed that, when setting the difference in diameter of the spherical spacer 103a and the spherical spacer 103b to be in the range of approximately 2% to 20% of the diameter of the spherical spacer 103a, the performance of the following of the spacers to a gap change is enhanced so that the non-uniformity of the gap can be effectively controlled. Furthermore, although there are herein used two kinds of spacers including the spherical spacer 103a having a relatively large diameter and the spherical spacer 103b having a relatively small diameter, it is possible to use more than two kinds of spacers each having a different size. In FIG. 1, the spherical spacers 103a and the spherical spacers 103b are disposed between (over the gate wiring 104) pixels adjacent to each other in the vertical direction in the drawing. That is, the spherical spacers 103a and the spherical spacers 103b are disposed over the gate wiring 104. As shown in FIG. 4, the spherical spacers 103a and the spherical spacers 103b may be also disposed, for example, between (over the drain wiring 105) pixels adjacent to each other in the horizontal direction in the drawing. That is, the spherical spacers 103a and the spherical spacers 103b may be disposed over the drain wiring 105. Furthermore, the spherical spacers 103a and the spherical spacers 103b may be disposed both between (over the gate wiring 104) the vertically adjacent pixels and between (over the drain wiring 105) the horizontally adjacent pixels.

In FIG. 1, although the shape of the recessed part 101 is rectangular, it may be of any shape as long as the spherical spacers 103a and 103b engage with the recessed parts 101. For example, the shape may be triangular, polygonal, circular, elliptical or the like. In addition, in FIG. 2, although the spherical spacers 103a and the spherical spacers 103b are put so that these spacers 103a and 103b are in contact only with the bottom surfaces of the recessed parts 101, the sizes of the recessed parts 101 can be appropriately adjusted so that, for example, the spherical spacers 103a and the spherical spacers 103b may be put to be in contact with the bottom surfaces and the sidewall surfaces of the recessed parts 101 or in contact only with the sidewall surfaces thereof. Furthermore, in FIG. 2, the recessed part 101 is formed by partly removing the flattened film 111 so that parts of the passivation film 108 serving as the foundation layer are exposed. However, to form a recessed part 101, without completely removing the corresponding part of the flattened film 111, the flattened part 111 may remain thin on the bottom of the recessed part 101. Furthermore, the tilt angles of the sidewall surfaces of the recessed part 101 are arbitrary. Although the sidewall surfaces may be formed perpendicular to the surface of the substrate, the sidewalls may be tilted so as to enable the spherical spacers 103a and the spherical spacers 103b to be easily fallen down along the tilted sidewalls of the recessed part 101.

In FIGS. 1 and 2, there is shown a twisted nematic (hereinafter abbreviated as TN) LCD panel in which the liquid crystal material 122 is driven with an electric field between the pixel electrode 109 formed on the TFT electrode 120 and the counter electrode 115 formed on the CF substrate 121. However, as in the case of the TN LCD panel, what is described above is also applicable to a vertical alignment (hereinafter abbreviated as VA) LCD panel in which liquid crystal material is driven with an electric field between a pixel electrode formed on a TFT substrate and a counter electrode formed on a CF substrate. Furthermore, what is described above is also applicable to an in-plane switching (hereinafter abbreviated as IPS) LCD panel in which liquid crystal material is driven with an electric field between a pair of electrodes formed on a TFT substrate. In the case of the IPS LCD panel, since the pair of electrodes which drive the liquid crystal material is formed on the TFT substrate, it is not necessary to provide the counter electrode 115 on the CF substrate 121 of FIG. 2. In the case of the IPS LCD panel, it is conceivable to design the panel by defining the spacing between a main surface of the flattened film 111 of the TFT substrate 120 and the color layers 114 of the CF substrate 121 shown in FIG. 2 as the cell gap. The present invention is intended to control the non-uniformity of the gap due to a temperature change and/or non-uniformity in display due to strains generated by stresses and is applicable to various kinds of driving systems for liquid crystal material and of display modes without departing from the scope of the object of the present invention. Moreover, the TFT may be of inversely staggered type (bottom gate type) or of positive stagger type (top gate type); and there is no particular limitation on the shapes, disposition, materials and the like of the constituent elements other than the spherical spacers 103a, the spherical spacers 103b and the recessed parts 101.

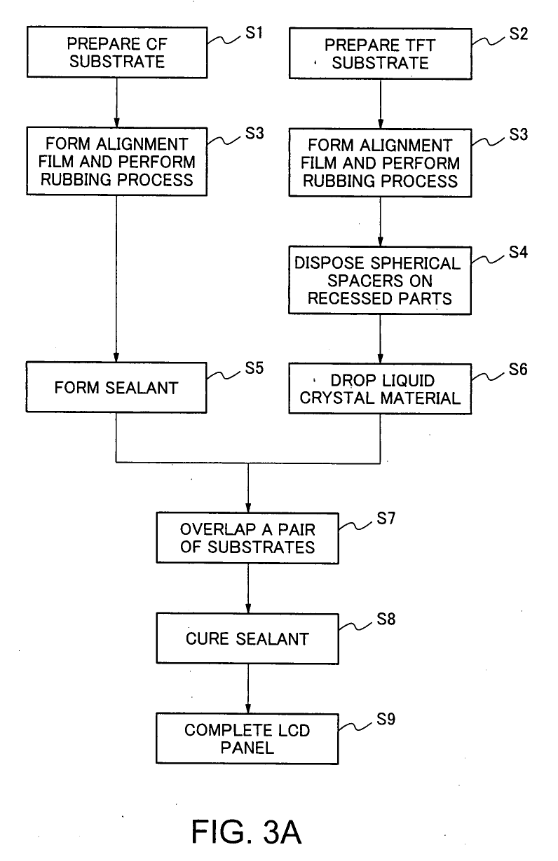

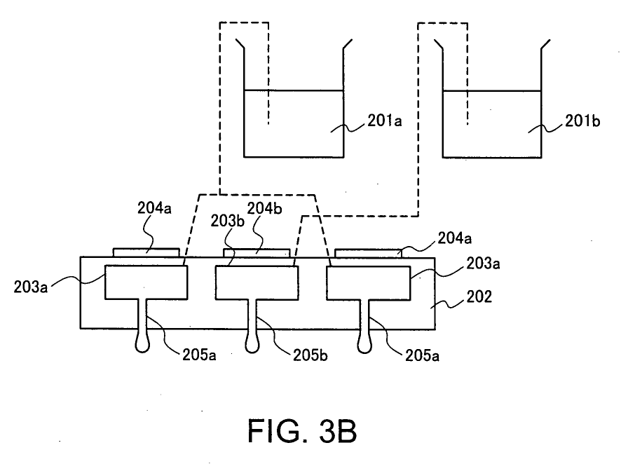

Next, a method of manufacturing such LCD panels is described with reference to a flowchart shown in FIG. 3A.

First, in step S1, the CFT substrate 121 is prepared. The CF substrate 121 is formed in a way that a black matrix 113 is formed by a photolithographic method in an area between pixels on the glass substrate 112; thereafter, the color layers 114 of respective colors, RGB, are formed by a photolithographic method in the areas of respective pixels; and the counter electrode 115 made of a transparent conductive film such as indium tin oxide (ITO) is formed by a sputtering method or the like. The materials, the methods of forming, the forming areas, the thicknesses and the like of the black matrix 113, the color layers 114, and the counter electrode 115 are not limited to the constitution in the drawings.

Next, in step S2, the TFT substrate 120 is prepared. The TFT substrate 120 is formed in a way that the gate wirings 104 and the gate electrodes are formed on another piece of the glass substrate 112 by a sputtering method or the like; and at the same time, the gate light-shielding parts 118 for shielding light leaked from the peripherals of pixels are formed. Subsequently, the gate insulating film 107 made of a silicon dioxide film, a silicon nitride film or the like is formed by a vacuum evaporation method, plasma chemical vapor deposition (CVD) method or the like; on the gate insulating film 107, semiconductor layers made of amorphous silicon, polycrystalline silicon or the like are formed; and thereafter, the drain wirings 105, drain electrodes and source electrodes are formed by a sputtering method or the like. The TFT 117 constituted of the gate electrode, the gate insulating film 107, the semiconductor layers, the drain electrode and the source electrode is formed. The passivation film 108 is formed by a vacuum evaporation method or the like. Subsequently, the flattened film 111 made of photosensitive organic layers, a silicon dioxide film, a silicon nitride film or the like is formed by a coating method, a vacuum evaporation method, a plasma CVD or the like; and the recessed part 101 is formed in a light-shielding area by a photolithographic method. Here, the light-shielding area designates an area where the gate wirings 104 and the drain wirings 105 of the TFT substrate 120 are disposed, or an area where the black matrix 113 of the CF substrate 121 is disposed. Thereafter, the pixel electrodes 109 made of transparent conductive films such as ITO are formed by a sputtering method or the like. There is no particular limitation on the materials, the methods of forming, the forming areas, the thicknesses and the like of the gate wirings 104, the gate light-shielding parts 118, the gate insulating film 107, the semiconductor layers, the drain wirings 105 and the pixel electrodes 109.

Next, in Step S3, the TFT substrate 120 and the CF substrate 121 are respectively cleaned; and solution of polyimide being a material of an alignment film is applied thereto by using a printer or the like to be thereafter baked, thus forming an alignment film. Thereafter, a rubbing process is performed, in which a surface of the alignment film is rubbed in one direction using a buff wrapped around a rotating metallic roller. Next, to remove residue produced after the rubbing process such as fabric scrap of the buff and scrape resulting from the rubbing of the alignment film, the cleaning of the substrates and the drying thereof are performed.

Next, in Step S4, the spherical spacers 103a and the spherical spacers 103b are disposed on the recessed parts 101 of the TFT substrate 120. When using an ink jet method as a method of disposing the spherical spacers on fixed places, inks in which spherical spacers having different diameters are dispersed are discharged over the recessed parts 101 through plural ink jet nozzles, and heat treatment is performed on the substrate on which the spherical spacers are disposed, whereby the spherical spacers are firmly fixed on the substrate.

As an example of the ink jet method, a discharging method using a piezo ink jet head 202 is described with reference to FIG. 3B. The ink jet head 202 includes piezo elements 204a and 204b, tanks 203a and 203b in which inks to be supplied are reserved, and nozzles 205a and 205b discharging the inks. To the ink jet head 202, the ink 201a in which the spherical spacers 103a each having a relatively large diameter are dispersed, and the ink 201b in which the spherical spacers 103b each having a relatively small diameter are dispersed are supplied. Nozzle pitch being the spacing between the nozzles of the ink jet head 202 is designed so as to correspond to the pitch between the recessed parts 101 on the TFT substrate 120. When voltages are applied to the piezo elements 204a and 204b, the piezo elements 204a and 204b deform, and then cause the tanks 203a and 203b to deform, so that the inks reserved therein are pushed out. The inks are discharged through the nozzles 205a and 205b. In this manner, the ink 201a in which the spherical spacers 103a each having a relatively large diameter are dispersed and the ink 201b in which the spherical spacers 103b each having a relatively small diameter are dispersed are respectively discharged in the recessed parts 101 of the TFT substrate 120. In this way, the spherical spacers 103a and 103b shown in FIG. 2 are disposed on the fixed places. In this case, a kind of ink, in which spherical spacers are dispersed, to be supplied to the ink jet head 202, and the nozzle pitch of, the ink jet head 202 are designed by considering the disposition and pitch of the recessed parts 101 on the TFT substrate 120.

Thereafter, a photocuring sealant or a thermal curing sealant is formed on any one of the substrates and, further, liquid crystal material is dropped on the other substrate. For example, in FIG. 3A, a sealant is formed on the CF substrate 121 in Step S5, and liquid crystal material is dropped on the TFT substrate 120 in Step S6. Furthermore, in Step S7, the TFT substrate 120 and the CF substrate 121 are put to face each other to be thereafter overlapped. In Step S8, photocuring of a sealant and thermal curing of the same are performed, thus forming an LCD panel in Step S9. As the photocuring of the sealant, curing by irradiation of ultraviolet is used. As to the forming of the sealant and the dropping of the liquid crystal material, the sealant may be formed on the TFT substrate 120, and the liquid crystal material may be dropped on the CF substrate 121. Further, sealant may be formed on the TFT substrate 120, and the liquid crystal material may be dropped on the TFT substrate 120. Moreover, sealant may be formed on the CF substrate 121, and the liquid crystal material may be dropped on the CF substrate 121.

Furthermore, when using an offset printing method instead of the ink jet method, the spherical spacers 103a and 103b are offset-printed on predetermined recessed parts 101 and heated to be thereby firmly fixed. Thereafter, a sequence of processes up to an alignment process is performed on each of the TFT substrate and CF substrate, the sequence thereof being the cleaning of the substrates, the printing of the alignment film, the baking of the alignment film, the rubbing process, the cleaning of the substrates after the rubbing process, and the drying of the substrates. Thereafter, a photocuring sealant or a thermal curing sealant is formed on one of the substrates and, further, liquid crystal material is dropped on the other substrate. In an overlapping process, the both substrates facing each other are overlapped, and then, UV curing of a sealant and thermal curing of the same are performed and, thus, an LCD panel is completed.

As in the manner described above, the flattened film 111 of the TFT substrate is removed to form the recessed parts 101, and the spherical spacers 103a and the spherical spacers 103b each having a different diameter are disposed on the flattened parts 101, whereby the performance of following of the spacers to a gap change due to a temperature change is enhanced so that the non-uniformity of the gap can be effectively controlled. Furthermore, by setting the diameters of the spherical spacers to be larger than the cell gap, a margin to a gap change can be made large. Because of the presence of the recessed parts 101, the moving of the spherical spacers 103a and 103b due to the overlapping of the substrates, vibration, and/or impact is restrained and, consequently, it becomes hard for light leakage and the non-uniformity of the gap to occur, so that reliability can be enhanced. Furthermore, it is possible to collect the spherical spacers 103a and 103b on the recessed parts 101, which do not dry till the last, and to cause the spherical spacers to define their positions in a self-aligned manner, so that the accuracy of the positions of the spherical spacers can be enhanced.

### Second Exemplary Embodiment

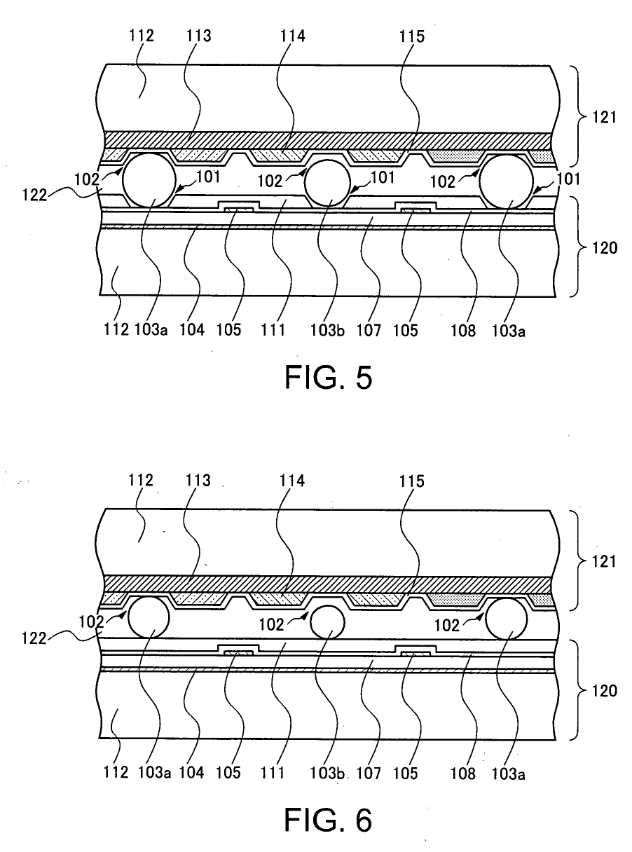

Next, an LCD panel of a second exemplary embodiment of the present invention and a method of manufacturing the LCD panel are described with reference to FIGS. 4 and 5.

Although the recessed parts 101 are formed on the TFT substrate only in the above-described first exemplary embodiment, a feature of the present embodiment is that recessed parts 101 and 102 are respectively formed on both of a TFT substrate and a CF substrate. That is, the recessed parts 101 are formed on the TFT substrate 120 and the recessed parts 102 are formed on the CF substrate 121. In the case where plural aforementioned recessed, parts 101 are disposed on the TFT substrate 120, they are formed to have the same depth, and in the case where plural aforementioned recessed parts 102 are disposed on the CF substrate 121, they are also formed to have the same depth.

Although the LCD panel of the present embodiment has a constitution which is roughly the same as that of the first exemplary embodiment, the LCD panel of the present embodiment is different in that, on the areas where the spherical spacers 103a and 103b are disposed, the recessed parts 102 are also provided on the CF substrate 121. These recessed parts 102 are formed by removing parts of color layers 114 facing the recessed parts 101 when forming the color layers 114 by a photolithographic method. Furthermore, the recessed parts 102 can be easily formed by not forming the color layers 114 on part facing the recessed parts 101.

That is, in Step S1 of the flowchart of FIG. 3A, by changing the process of preparing the CF substrate 121, the LCD panel of the present embodiment can be manufactured. First, in Step S1, the CF substrate 121 is prepared. The CF substrate 121 is formed in a way that a black matrix 113 is formed by a photolithographic method in an area between pixels on the glass substrate 112, and thereafter, the color layers 114 of respective colors, RGB, are formed by a photolithographic method in the areas of respective pixels. At this time, specific parts of the color layers 114 facing the recessed parts 101 of the TFT substrate 120 are removed. Alternatively, the color layer 114 is not formed on the parts facing the recessed parts 101. Furthermore, counter electrodes 115 formed of iridium tin oxide (ITO) are formed using a sputtering method or the like. In this manner, the CF substrate 121 on which the recessed parts 102 are formed is prepared as a counter substrate. As in the first exemplary embodiment, the materials, the methods of forming, the forming areas, the thicknesses and the like of the black matrix 113, the color layers 114, and the counter electrode 115 are not limited to the constitution in the drawing.

Using the above-described CF substrate 121 and proceeding Steps S1 through S9, the LCD panel of the second exemplary embodiment is completed as in the first exemplary embodiment.

In the present embodiment too, the shapes of the recessed parts 101 and 102 may be of any shape as long as the spherical spacers 103a and 103b engage with the recessed parts 101 and 102. For example, the recessed parts 101 and 102 may be of arbitrary shape being rectangular, triangular, polygonal, circular, elliptical or the like. Furthermore, the shape of the recessed parts 102 may be the same as or different from that of the recessed parts 101 of the TFT substrate 120. In addition, the spherical spacers 103a and the spherical spacers 103b may be put in a manner that these spacers 103a and 103b are in contact only with the bottom surfaces of the recessed parts 101 and 102, in contact with the bottom surfaces and the sidewall surfaces of the recessed parts 101 and 102, or in contact only with the sidewall surfaces of the recessed parts 101 and 102. Moreover, in FIG. 5, the parts of the color layers 114 are removed so that the corresponding parts of the black matrix 113 serving as the foundation layer are exposed. However, in order to form a recessed part, for example, without completely removing the part of the color layers 114, the part thereof may remain thin on the bottom of the recessed part 102. Moreover, the tilting angles of the sidewall surfaces of the recessed parts 101 and 102 are arbitrary and, hence, the sidewall may be perpendicular to the surface of the substrate, or may be tilted.

By forming the constitution as described above, the diameter of the spherical spacers can be increased, thus enabling further increase of a margin to a gap change. Furthermore, the moving of the spherical spacers due to the overlapping of the substrates, vibration, and/or impact is restrained and, consequently, it becomes hard for light leakage and the non-uniformity of the gap to occur, so that reliability can be further enhanced.

In the first exemplary embodiment, the recessed parts 101 are formed on the TFT substrate 120. In the present embodiment, although the recessed parts 101 are formed on the TFT substrate 120 and the recessed parts 102 are formed on the CF substrate 121, only the recessed parts 102 may be formed on the CF substrate 121 as shown in FIG. 6. In this case, the spherical spacers 103a, 103b are respectively disposed on the recessed parts 102 of the CF substrate 121.

### Third Exemplary Embodiment

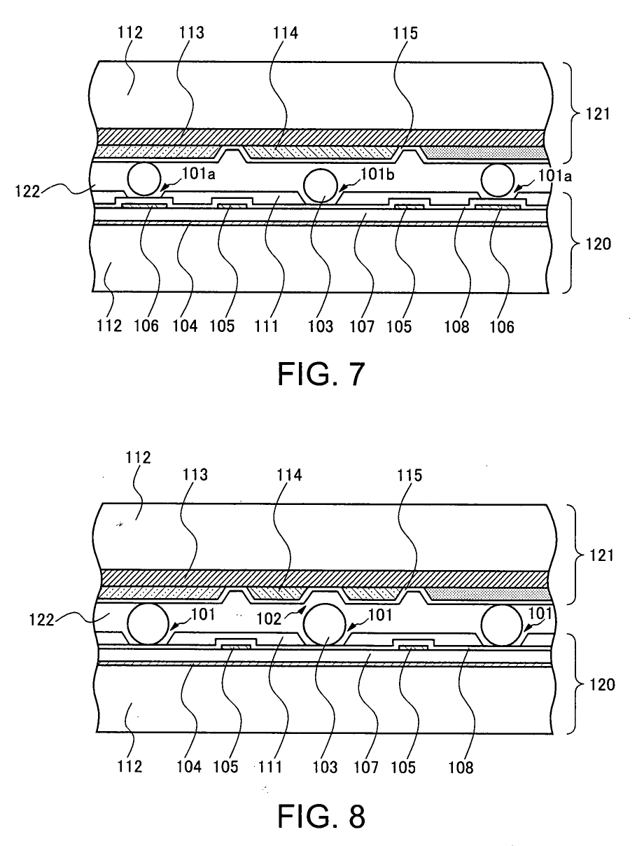

Next, an LCD panel according to a third exemplary embodiment of the present invention and a method of manufacturing the LCD panel are described with reference to FIGS. 7 and 8.

In the above-described first and second exemplary embodiments, the descriptions are given of the case where the recessed parts 101 and 102 are formed so that they have the same depths. A feature of the present embodiment is that recessed parts having different depths are formed on one substrate. In the above-described first and second exemplary embodiments, the descriptions are given of the case where multiple kinds of spherical spacers each having a different diameter are used. In the present embodiment, a description is given of the case where one kind of spherical spacers is used.

As shown in FIG. 7, a TFT substrate 120 includes a glass substrate 112, gate wirings 104 and gate light-shielding parts 118 formed by a photolithographic method; gate insulating films 107; and TFTs 117 formed of amorphous silicon, polycrystalline silicon or the like. Furthermore, the TFT substrate 120 includes drain wirings 105 formed by a photolithographic method; gap adjusting films 106 formed of the same material as that of the drain wirings 105; a passivation film 108; a flattened film 111 formed of a photosensitive organic film or the like; recessed parts which are formed by removing parts of the flattened film and which have different depth depending on the presence or absence of the gap adjusting films 106; and pixel electrodes 109. As an example of the recessed parts having different depths depending on the presence or absence of the gap adjusting films 106, recessed parts 101a having a relatively small depth are formed, and recessed parts 101b having a relatively large depth are formed. Furthermore, spherical spacers 103 are disposed on the recessed parts 101a and the recessed parts 101b by an ink jet method or the like. The ratio of the gap at the recessed part 101a to the diameter of the spherical spacer 103 disposed on the recessed part 101a is thereby different from the ratio of the gap at the recessed part 101b to a diameter of the spherical spacer 103 disposed on the recessed part 101b.

The gap adjusting films 106 can be formed on light-shielding areas placed over the gate wirings 104, at the same time when forming the drain wirings 105. That is, by changing the process of preparing the TFT substrate 120 in Step S2 of the flowchart of FIG. 3A, the LCD panel of the present embodiment can be manufactured. First, in Step S1, a CF substrate 121 is prepared as in the first exemplary embodiment. Then, in Step S2, the TFT substrate 120 is prepared. As in the first exemplary embodiment, on the glass substrate 112, the gate wirings 104, gate electrodes and the gate light-shielding parts 118 are formed, then, the gate insulating film 107 is formed, and semiconductor layers are formed thereon. Next, the drain wirings 105, the drain electrodes and the source electrodes are formed by a sputtering method or the like. At this time, the gap adjusting films 106 are selectively formed on the light-shielding areas placed over the gate wirings 104. The passivation film 108 is formed by a vacuum evaporation method or the like. Furthermore, a flattened film 111 is formed, and recessed parts 101 are formed on the light-shielding areas by a photolithographic method. On the positions where the gap adjusting films 106 are present, the recessed parts 101a having a relatively small depth are formed, and the recessed parts 101b having a relatively large depth are formed on the positions where the gap adjusting films 106 are absent. Thereafter, the pixel electrodes 109 made of ITO or the like are formed by a sputtering method or the like. In this manner, the TFT substrate 120 on which plural aforementioned recessed parts 101 having different depths are formed are prepared. Using the TFT substrate 120 described above and proceeding Steps S1 to S9 as in the first exemplary embodiment, the LCD panel of the third exemplary embodiment is completed.

There is no particular limitation on the film thicknesses and sizes of respective members constituting the above-described LCD panel. However, for example, it is assumed that the thickness of the flattened film 111 is 1.0 μm; the diameter of the spherical spacer 103 is 3.8 μm; and the film thicknesses of the drain wiring 105 and the gap adjusting film 106 is 0.4 μm. Here, the spacing between a main surface of the flattened film 111 and the counter electrodes 115 is also defined as the cell gap. When setting this cell gap to 3.0 μm and when forming the cell in a state in which the spherical spacers 103 are being compressed by 0.2 μm on the recessed parts 101a where the gap adjusting films 106 are present, the spherical spacers 103b are put in a state where the same are free to move by 0.2 μm on the recessed parts 101b where the gap adjusting films 106 are absent.

For the LCD panel of the present embodiment, the both substrates facing each other are supported mainly with the spherical spacers 103 on the recessed parts 101a where the gap adjusting films 106 are present; and when the magnitude of the gap is changed, the both substrates facing each other are supported with the spherical spacers 103 on the recessed parts 101b where the gap adjusting films 106 are absent. The disposition density of the spherical spacers 103, which are secondarily formed and which are disposed on the recessed parts 101b where the gap adjusting films 106 are absent, is desired to be set to several times greater than that of the spherical spacers 103 with which the both substrates facing each other are mainly supported and which are disposed on the recessed parts 101a where the gap adjusting films 106 are present. This disposition density may be adjusted by changing the disposition densities of the recessed parts 101a and the recessed parts 101b. For example, the adjusting of the disposition density may be achieved by forming the recessed parts 101a and 101b in such a manner that the number of the recessed parts 101b where the gap adjusting films 106 are absent is several times greater than that of the recessed parts 101a where the gap adjusting films 106 are present. Furthermore, it is possible to adjust these deposition densities by the number of deposition points and/or by the number of spacers disposed at one place.

Although it is only expected herein that the recessed parts 101b are deeper than the recessed parts 101a, when setting the difference in depth between these recessed parts to be in the range of approximately 2% to 20% of the diameter of the spherical spacer 103, the performance of following of the spacers to a gap change is enhanced so that the non-uniformity of the gap can be effectively controlled. Furthermore, although there are herein shown two kinds of recessed parts, one being the recessed part 101a having a relatively small depth and the other being the recessed part 101b having a relatively large depth, it is possible to use more than two kinds of recessed parts each having a different depth.

As described above, the changing of the depth of the recessed parts formed on the TFT substrate 120 is also capable of enhancing the performance of following of the spacers to a gap change due to a temperature change, as in the first exemplary embodiment, so that the non-uniformity of the gap can be controlled. Moreover, because of the presence of the recessed parts 101a and 101b, the moving of the spherical spacers 103 due to the overlapping of the substrates, vibration, and/or impact is restrained and, consequently, it becomes hard for light leakage and the non-uniformity of the gap to occur. Thus, reliability can be enhanced. Furthermore, it is possible to collect the spherical spacers 103 on the recessed parts 101a and 101b which do not dry till the last, and to cause the spherical spacers to define their positions in a self-aligned manner, so that the accuracy of the positions of the spherical spacers can be enhanced.

In FIG. 7, although the depth of the recessed parts 101 are changed with the gap adjusting films 106 formed on the same layer as the drain wirings 105, when forming the recessed parts between (i.e., over the drain wiring 105) pixels adjacent to each other in the horizontal direction in FIG. 1, the gap may be adjusted with a film formed on the same layer as the gate wirings 104. Furthermore, a film for adjusting the gap may be separately formed. This film formed separately for adjusting the gap may be of a metal film or an insulation film. Moreover, instead of providing the gap adjusting films 106, by changing the exposure condition of, or the etching condition of the flattened film 111, the depth of the recessed parts 101 may be changed. In this manner, the recessed parts 101 having different depths can be formed using various realization means. The realization means is selectable according to the structure and the manufacturing method of an LCD panel to be manufactured.

Furthermore, in FIG. 7, the recessed parts 101a and 101b are formed on the TFT substrate 120. However, in FIG. 8, the recessed parts 101 having the same depth are formed on the TFT substrate 120, and the recessed parts 102 are formed on parts of the CF substrate 121 so that the parts face some of the recessed parts 101. Consequently, in FIG. 8, the same advantage as that produced in FIG. 7 can be obtained although the spacing between the substrates at a position where the recessed part 101 and the recessed part 102 face each other is large and the spacing between the substrates at a position where only the recessed part 101 is formed is small. In the case of FIG. 8, a recessed part 102 is formed on a part of the CF substrate 121, the part facing a middle recessed part 101 of the TFT substrate 120. The ratio of the gap at the recessed part 101 to the diameter of the spherical spacer 103 disposed on the recessed part 101 is thereby different from the ratio of the gap at the recessed part 102 to a diameter of the spherical spacer 103 disposed on the recessed part 102.

### Fourth Exemplary Embodiment

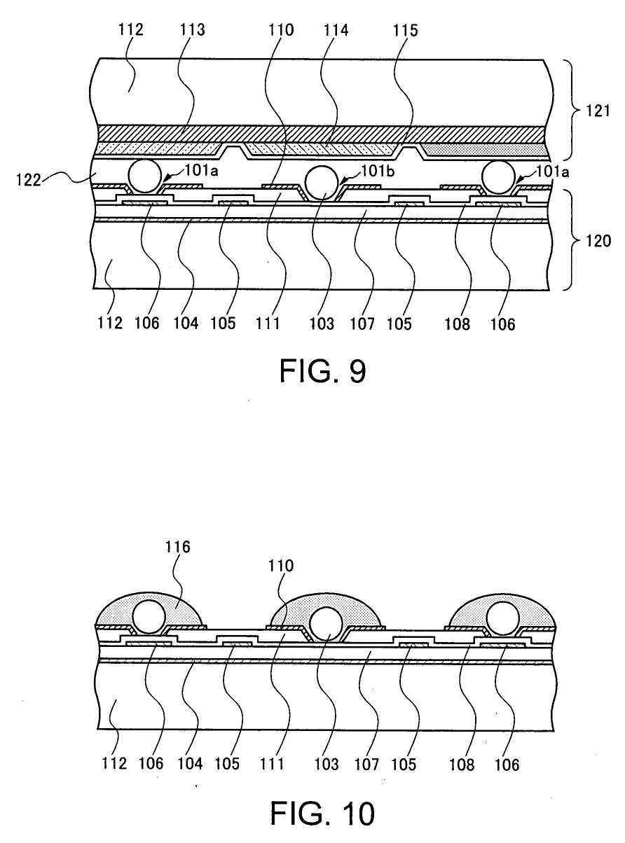

Next, an LCD panel of a fourth exemplary embodiment of the present invention and a method of manufacturing the LCD panel are described with reference to FIGS. 9 and 10.

As in the first to third exemplary embodiments, by disposing the spacers on the recessed parts, it is possible to collect the spherical spacers on the recessed parts, which do not dry till the last, and to cause the spherical spacers to define their own positions in a self-aligned manner. A feature of the present embodiment, however, is that further enhancement of the accuracy of the positions of the spherical spacers is achieved.

As shown in FIG. 9, a TFT substrate 120 includes a glass substrate 112, gate wirings 104 and gate light-shielding parts 118 formed by a photolithographic method; gate insulating films 107; and TFTs 117 formed of amorphous silicon, polycrystalline silicon or the like. Furthermore, the TFT substrate 120 includes drain wirings 105 formed by a photolithographic method; gap adjusting films 106 formed of the same material as that of the drain wirings 105; a passivation film 108; a flattened film 111 formed of a photosensitive organic film or the like; recessed parts which are formed by removing parts of the flattened film and which have different depth depending on the presence or absence of the gap adjusting films 106; high contact angle films 110 formed by a photolithography method; and pixel electrodes 109. Moreover, spherical spacers 103 are disposed on the recessed parts 101a and the recessed parts 101b by an ink jet method or the like. As an example of the recessed parts having different depths depending on the presence or absence of the gap adjusting films 106, there are formed recessed parts 101a, having a relatively small depth, and recessed part 101b, having a relatively large depth. The ratio of the gap at the recessed part 101a to the diameter of the spherical spacer 103 disposed on the recessed part 101a is thereby different from the ratio of the gap at the recessed part 101b to a diameter of the spherical spacer 103 disposed on the recessed part 101b.

The present embodiment is different from the aforementioned third exemplary embodiment in that, on the near areas surrounding the recessed parts 101a and 101b, the high contact angle films 110, the contact angles of which are larger than those of the recessed parts 101a and 101b, are disposed. It is expected that each of the high contact angle films 110 is formed by a member having a contact angle, which is larger than that of an exposed part of an inner surface of the recessed part. For example, each of the high contact angle films 110 may be formed by a transparent conductive film, which is the same as a pixel electrode 109. Specifically, when a transparent conductive film is patterned to form the pixel electrode 109, a transparent conductive film is simultaneously patterned to form the high contact angle film 110 on a light-shielding area. Alternatively, when the recessed parts 101a and 101b are formed of SiN films and when the near areas surrounding the recessed parts 101a and 101b are formed by photosensitive organic films, since the photosensitive organic film has a larger contact angle as compared with that of the SiN film, an area having the high contact angle can be obtained at the same time when the recessed parts 101a and 101b are formed.

It should be noted that although there is no particular limitation on the area and film thickness of the high contact angle film 110, it is preferred that they be designed by considering the accuracy of printing position. For example, in FIG. 9, although the high contact angle film 110 is formed on the surrounding area and the sidewall surface of a recessed part 101, it may be formed on the surrounding area only, or on a part of the surrounding area.

The LCD panel of the present embodiment can be manufactured by changing the process of preparing the TFT substrate 120 in Step S2 of the flowchart of FIG. 3A. First, the CF substrate 121 is prepared in Step S1 as in the first and third exemplary embodiments. Subsequently, the TFT substrate 120 is prepared in Step S2. As in the first and third exemplary embodiments, on the glass substrate 112, the gate wirings 104, the gate electrodes and the gate light-shielding parts 118 are formed, and the gate insulating films 107 are formed, and then, semiconductor layers are formed thereon. Next, the drain wirings 105, the drain electrodes and the source electrodes are formed by a sputtering method or the like. At this time, the gap adjusting films 106 are also selectively formed. The passivation film 108 is formed by a vacuum evaporation method or the like. Furthermore, a flattened film 111 is formed, and the recessed parts 101a and the recessed parts 101b are formed on light-shielding areas by a photolithographic method. Thereafter, the pixel electrodes 109 made of transparent conductive films such as ITO are formed by a sputtering method or the like. At this time, high contact angle films 110 made of the same transparent conductive film as the pixel electrodes 109 are formed on the recessed parts 101a and 101b over the gate film 104. In this way, the TFT substrate 120 of the present embodiment can be prepared. Subsequently, as in the first and third exemplary embodiments, in Step S3, alignment films are formed on the TFT substrate 120 and the CF substrate 121, and a rubbing process is performed.

Next, in Step S4, the spherical spacers 103 are disposed on the recessed parts 101a and the recessed parts 101b. Ink 116 in which the spherical spacers 103 are dispersed is discharged to the recessed parts 101a and 101b through inkjet nozzles, and heat treatment is performed on the substrate.

Because of the presence of the high contact angle films 110 disposed on the near areas surrounding the recessed parts 101a and 101b, the ink 116 is collected on the recessed parts 101a and 101b having small contact angles at the time when the ink 116 has dried. This allows the spherical spacers 103 to correct their own positions in a self-aligned manner, so that further enhancement of the accuracy of the positions of the spherical spacers 103 can be achieved. Thereafter, proceeding Steps S5 thorough S9 as in the first exemplary embodiment, the LCD panel of the fourth exemplary embodiment is completed.

In general, it is hard for the spherical spacers to be disposed within predetermined light-shielding areas with high accuracy, when relying only on printing accuracy dependent on the ink jet method or the offset printing method. In the present embodiment, while drying of the ink 116 is progressing in an isotropic manner, the ink 116 remains fresh on the recessed parts 101a and 101b till the last. The spherical spacers 103 can be collected on the recessed parts 101a and 101b which have not dried till the last. Furthermore, the positions of the spherical spacers 103 being disposed can be corrected in a self-aligned manner using the effect in which, by setting the contact angles of the near areas surrounding the recessed parts 101a and 101b to be large compared to the contact angles of the inner surfaces of the recessed parts 101a and 101b, the ink 116 is collected to the areas having small contact angles when the ink has dried.

Moreover, in the present embodiment, there is shown the case where the high contact angle films 110 is formed in the LCD panel of the third exemplary embodiment. The same advantage can be also obtained by forming the high contact angle films 110 in the LCD panel of one of the first and second exemplary embodiments.

In the first and second exemplary embodiments, the descriptions are given of the cases where plural aforementioned recessed parts 101 and 102 are formed on the TFT substrate 120, or the CF substrate 121 or on both of them, and plural spherical spacers having different diameters are distributed. That is, for the plural spherical spacers having different diameters, there are used the spherical spacers 103a having a relatively large diameter and the spherical spacers 103b having a relatively small diameter. In the third exemplary embodiment, the description is given of the case where the multiple of recessed parts having different depths are formed on one of the TFT substrate 120 and the CF substrate 121, or the recessed parts are formed on the TFT substrate 120 and the CF substrate 121 in a way that some of the recessed parts face each other; and the spherical spacers 103 having the same size are disposed. That is, for the plural recessed parts having different depths, there are used the recessed part 101a having a relatively small depth and the recessed part 101b having a relatively large depth. In the fourth exemplary embodiment, the high contact angle films are formed on the near areas surrounding the recessed parts. In the present invention, an LCD panel may be constituted by arbitrarily combining the features of the first to fourth exemplary embodiments.

Although the descriptions described above have been given using the preferred exemplary embodiments, the present invention is not limited to these embodiments, and various changes can be made therein without departing form the spirit of the present invention. For example, in the above-described embodiments, although the ink jet head is described with reference to the piezo type, it is not limited to this, and another type is also applicable. For example, an ink jet head of bubblejet® type can be adopted. In this ink jet head, a heater is placed next to a tank in which ink is stored. The ink in the tank is heated by power supplied to the heater, whereby expansion and bubbles occurs in the ink so that the ink is discharged through the nozzles of the ink jet head. To such an ink jet head, ink in which spherical spacers are dispersed is supplied to be thereby discharged to recessed parts in light-shielding areas, thus enabling the spherical spacers to be disposed on the recessed parts.

Furthermore, using an ink jet head in which plural nozzles are disposed on plural lines, ink in which spherical spacers are dispersed is simultaneously discharged to plural lines of light-shielding areas so that the spherical spacers can be disposed on the recessed parts. Moreover, ink jet heads are prepared for inks in which spherical spacers having different diameters are dispersed, and the inks are respectively discharged with these heads so that the spherical spacers having different diameters can be disposed on the recessed parts. It is conceivable that the discharging of ink in which spherical spacers are dispersed may be performed while moving the ink jet head over a substrate in the direction in which gate wirings are extended, or while moving the ink jet head over a substrate in the direction in which drain wirings are extended.

In the above-described embodiments, although the descriptions are given of the case where the TFTs are used as switching elements, the present invention is also applicable to an LCD panel in which a switching element such a thin-film diode (TFD) or a metal insulator metal (MIM) is used. Furthermore, in the above-described embodiments, although the descriptions are given of the case where the color layers are formed on the counter substrate, the present invention is also applicable to an LCD panel of color-filter-on TFT type in which color filters are formed on a TFT substrate. For a monochrome display LCD panel, the color layers are not necessary.

Moreover, in the above-described embodiments, although the descriptions are given by applying the present invention to a transmissive LCD panel which is formed by the pixel electrodes 109 and counter electrodes 105, the present invention is also applicable to a reflective LCD panel or a semi-transmissive LCD panel. In the case of the reflective LCD panel, a reflective plate is placed inside or outside of an LCD panel; and a pixel electrode itself is formed by a light reflective pixel electrode. In the case of the semi-transmissive LCD panel having a reflective area and a transmissive area, a reflective plate is disposed on a reflective area inside or outside of an LCD panel, and part of a pixel electrode is formed of a light reflective material. In such a reflective LCD panel or such a semi-transmissive LCD panel too, the present invention in which recessed parts are disposed on light-shielding areas and spherical spacers are disposed on the recessed parts is applicable.

Although preferred embodiments of the invention has been described with reference to the drawings, it will be obvious to those skilled in the art that various changes or modifications may be made without departing from the true scope of the invention.

What is claimed is:

1. A liquid crystal display panel comprising:
a pair of substrates sandwiching liquid crystal material, at least one of the substrates have light-shielding parts viewing from normal direction to the substrate, plural recessed parts provided on the light-shielding parts; and
plural spherical spacers disposed on the recessed parts and controlling a gap between the pair of substrates in such a manner that there exists at least two different ratios of the gap at the recessed part to a diameter of the spacer disposed on the recessed part.

2. The liquid crystal display panel according to claim 1, wherein
the spherical spacers include plural kinds of spherical spacers, the diameters of which are different from one another to provide the different ratios.

3. The liquid crystal display panel according to claim 2, wherein
the spherical spacers include first spherical spacers each having a relatively large diameter, and second spherical spacers each having a relatively small diameter, and the number of the second spherical spacers is larger than that of the first spherical spacers.

4. The liquid crystal display panel according to claim 3, wherein
a difference in diameter between the first spherical spacers and the second spherical spacers is in a range of approximately 2% to 20% of the diameter of the first spherical spacers.

5. The liquid crystal display panel according to claim 1, wherein
the plural recessed parts include plural kinds of recessed parts, the depths of which are different from one another to provide the different ratios.

6. The liquid crystal display panel according to claim 5, wherein
the plural kinds of recessed parts include first recessed parts each having a relatively small depth and second recessed parts each having a relatively large depth, and the number of the second recessed parts is larger than that of the first recessed parts.

7. The liquid crystal display panel according to claim 6, wherein
a difference in depth between the first recessed parts and the second recessed parts is in a range of approximately 2% to 20% of the diameter of the spherical spacers.

8. The liquid crystal display panel according to claim 1, wherein
a near area surrounding each of the recessed parts is formed of a member having a contact angle larger than that of at least an area of the inner surface of the recessed part.

9. The liquid crystal display panel according to claim 8, wherein
at least an inner surface of each recessed part is formed of an inorganic film, and the near area surrounding each of the recessed part is formed of a photoreactive organic film.

10. The liquid crystal display panel according to claim 1, wherein,
on a near area surrounding each of the recessed parts, there is disposed a member having a contact angle larger than that of an area of the inner surface of the recessed part.

11. The liquid crystal display panel according to claim 10, wherein
an inner surface of each recessed part is formed of an insulating film, and the near area surrounding each of the recessed parts is formed of a transparent conductive film.

12. The liquid crystal display panel according to claim 1, wherein
the area where the light is shielded is an area on which a metallic wiring or a black matrix is formed.

13. A method of manufacturing a liquid crystal display panel, comprising:
a first step of forming plural recessed parts on an inner surface of at least one of a pair of substrates such that the recessed parts are located at a place where light is shielded in a direction normal to the substrate, and the surface being a liquid crystal sandwiching surface used to support the liquid crystal material;
a second step of disposing spherical spacers on the plural recessed parts; and
a third step of overlapping the pair of substrates for engaging the spherical spacers with the recessed parts between the substrates.

14. The method of manufacturing a liquid crystal display panel according to claim 13, wherein
the spherical spacers include plural kinds spherical spacers, the diameters of which are different from one another, and in the third step, the spherical spacers having a large diameter and the recessed parts are engaged, and the pair of substrates are overlapped.

15. The method of manufacturing a liquid crystal display panel according to claim 14, wherein
the spherical spacers include first spherical spacers each having a relatively large diameter and second spherical spacers each having a relatively small diameter, and the second spherical spacers and the first spherical spacers are disposed so that the number of the second spherical spacers is larger than that of the first spherical spacers.

16. The method of manufacturing a liquid crystal display panel according to claim 13, wherein,
in the second step, inks in which plural kinds of spherical spacers having diameters different from one another, respectively, are dispersed are discharged through separate ink jet nozzles so that the plural kinds of spherical spacers having different diameters are disposed on plural recessed parts.

17. The method of manufacturing a liquid crystal display panel according to claim 13, wherein,
in the first step, plural recessed parts, the depths of which are different from one another, are formed.

18. The method of manufacturing a liquid crystal display panel according to claim 17, wherein, in the third step, the spherical spacers and the recessed parts each having a small depth are engaged, and the pair of substrates are overlapped.

19. The method of manufacturing a liquid crystal display panel according to claim 17, wherein
the plural recessed parts include first recessed parts each having a relatively small depth and second recessed parts each having a relatively large depth, and the first and second recessed parts are formed so that the number of the second recessed parts is larger than that of the first recessed parts.

20. The method of manufacturing a liquid crystal display panel according to claim 13, wherein,
a contact angle of a near area surrounding each of the recessed parts is made larger than a contact angle of at least a part of the inner surface of the recessed part by forming plural members each having a different contact angle on the near area surrounding the recessed part, or by disposing a member having a contact angle larger than the contact angle of at least the part of the inner surface of the recessed part on the near area surrounding the recessed part.
